(19) United States
(12) Patent Application Publication
(10) Pub. No.: US 2014/0156458 A1
(43) Pub. Date: Jun. 5, 2014

(54) SYSTEMS AND METHODS FOR PROVIDING DIRECT FLORIST-TO-FLORIST TRANSACTIONS

(71) Applicant: VILER ANDRES BECERRA FIGUEROA, MIRAMAR, FL (US)

(72) Inventor: VILER ANDRES BECERRA FIGUEROA, MIRAMAR, FL (US)

(21) Appl. No.: 14/096,558

(22) Filed: Dec. 4, 2013

Related U.S. Application Data
(60) Provisional application No. 61/733,727, filed on Dec. 5, 2012.

(51) Int. Cl. G06Q 30/06

(52) U.S. Cl. CPC G06Q 30/0613
USPC 705/26.41

(57) ABSTRACT

A computer-implemented method for providing buyers with a unique purchasing experience based on buyer groups is disclosed. In one embodiment, a web service is provided. The web service lists a plurality of sellers. A list of products and related information based on buyer group of a buyer is displayed. Further, the web service facilitates a sale of one or more of the products based on buyer group of the buyer. Then a seller delivers the received order and receives buyer's feedback for the sale.

### RELATED APPLICATIONS

This application is based on and claims priority from Provisional Application Ser. No. 61/733,727 filed on Dec. 5, 2012.

### FIELD OF THE INVENTION

The present invention relates to the field of negotiating purchase prices between buyers and sellers of artisanal goods including flowers and, more specifically, systems and methods that allows sellers to provide buyers with a unique purchasing experience based on verifiable buyer groups and buyer special status.

### BACKGROUND OF THE INVENTION

The local florist is a brick and mortar business generally owned by one or more individuals who live in or near to their community. The local florists raise or sell flowers and ornamental plants plus other complementary services. The problem with current order processing is that an intermediary actor works as a bridge between buyers and sellers of various products. Although, the following discussion will focus on the floral industry, it is also applicable to other perishable goods; for example, edible fruit arrangements, ice sculptures, exotic dishes and artistic arrangements. The intermediary actor is a wire service or an order gatherer, which receives a cut on the sales price for the services provided, which leads to reduced profits for the sellers. Wire services are organizations where a retail florist in one area can reach out to a member florist in another area and transmit flower orders for his buyers. For example, a buyer approaches a local florist (an originating florist) who takes an order from the buyer. Then the originating florist sends the order to a delivering florist at a distant location via the wire service. Both the originating florist and the delivering florist receive a commission for the order. This system results in a situation where the delivering florist receives only 60%-75% of the sales price. Order Gatherers are organizations that advertise flowers for sale in television commercials and in online advertising. They gather orders directly from buyers and forward these orders to a wire service or to a local retail florist for delivery. The order gatherer retains a significant portion of the sales price, leaving the local florist with a small commission.

An alternate is that an originating florist directly places the order with a delivering florist. The originating florist may place the order by calling or faxing the delivering florist or by visiting website of the delivering florist. In this way, the florists can get better profits due to the elimination of the order gatherers and wire services. However, this process is cumbersome for the originating florist as the originating florist has to find a credible delivering florist in a particular region, then deal with the florist, setup the payment method and negotiate price of the product, shipping fee, and a determine a delivery schedule. Further, the process may be unmanageable for the florists as this is not a standard method and each florist may have different policies and techniques to process and accept orders, setup prices and delivery the products. Further, the delivering florist is unable to easily make the necessary changes to the sales order through their Point Of Sale (POS) terminal to adjust the delivery policy and delivery price appropriately.

In light of the foregoing, a need exists for a method and a system that optimizes the direct florist-to-florist connection using computers, databases, web network and physical servers. The present invention, in certain embodiments, achieves these objectives and others.

### SUMMARY

A computer-implemented method for providing buyers with a unique purchasing experience based on buyer groups is disclosed. In one embodiment, a web service is provided listing a plurality of sellers. A buyer visits the web service, which displays a list of products and related information based on buyer group of a buyer. Further, the web service facilitates a sale of one or more of the products based on buyer group of the buyer. Then a seller delivers the received order and receives buyer's feedback for the sale. The web service provides an order maker application, which is embedded on one or more seller web services and on point of sale of the sellers. An administrator of a seller web service may use one or more plug-ins with the order maker application, wherein the one or more plug-ins allow the order maker application to include additional functionality or to seamlessly interact with three party tools.

A computer readable medium encoded with a computer program comprising instructions that, when executed, operate to cause a computer to provide a unique purchasing experience based on buyer groups is disclosed. The instructions that, when executed, operate to cause a computer to perform operations including a buyer accessing a web service. Then, a list of products and related information is displayed based on a buyer group of a buyer. The web service facilitates a sales order of one or more of the products based on the buyer group of the buyer. Then a seller delivers the received order and receives buyer's feedback for the sale.

A system for providing buyers with a unique purchasing experience based on buyer groups is disclosed. The system includes a central web server hosting a central web service. The system further includes one or more seller web server hosting at one or more seller web services, wherein the central web service and the seller web services are connected via an Application Programming Interface (API). The central web service providing an order maker application that is embedded on the seller web services. The seller web service displays a list of products and related information based on a buyer group of a buyer, facilitates a sales order of one or more of the products based on the buyer group of the buyer. The system further includes one or more buyer communication devices used by the buyers to access at least one of the central web service and the seller web service, wherein the buyer receiving the sales order and providing a feedback for the sales order

Another object of the present disclosure is to allow to an administrator to create a price per each dependent product options for each different group.

Another object of the present disclosure is to allow to the administrator to create a different tax system and/or different tax brackets for each group, depending on the buyer level group tax setup.

Another object of the present disclosure is to allow to the administrator to create manually an account for a buyer and can determinate to which buyer groups the buyer belongs to; the process can be performed on the POS interface and/or the back office administration interface.

Another object of the present disclosure is to allow to the administrator to assign privileges per group in order to use or not coupons and regular discounts.

Another object of the present disclosure is to allow to the administrator to assign privileges per group in order to take advantage or not of products on especial or clearance.

Another object of the present disclosure is to allow to the administrator to assign privileges per group in order to take advantage or not of products on happy hour, special dates, holydays, seasons etc

Another object of the present disclosure is to allow to the administrator to create customized products, which can be on sale for a specific group or groups, also with different prices per group.

Another object of the present disclosure is to allow to the administrator to give to an Individual buyer customized treatment on shipping systems, payment method, and tax treatment.

Another object of the present disclosure is to allow to a buyer to create an account directly on the florist's E-Commerce web site getting an initial status of member of the default group; then the administrator can determinate to which buyer group the buyer belongs to; depending on the information given by the buyer.

Another object of the present disclosure is to allow to the administrator have the ability to deactivate or activate the buyer from any group, move a buyer to another group, or simply delete any buyer.

Another object of the present disclosure is to allow to the administrator to choose to send a product notification or newsletter to one or several buyer groups.

The present disclosure provides a method to use a system on the network or in the cloud, extranet, intranet, or internet, that allow to have different price levels for the same product for different users or group of users. The business method allows an originating florist forward an order to the delivering florist with delivery capabilities on the receiver location. The originating florist will get a special differentiated price from the delivering florist. The price for the originating flower could be different than the price given for example but not limited to a retail buyer, an institutional buyer, a wire service, an order gather, even to another originating flower etc.

Further, the present disclosure provides florists access to a social networking platform, and can enjoy interaction with other florist, member of the industry etc. Among many features, a florist can receive reviews from buyers, in another hand a user or originating florist can choose a preferred delivering florist to deliver an order, based on qualified credible reviews, rating and so on.

The present disclosure further provides a method that allows an administrator of originating florist who uses the same buyer differentiating system that is used by the delivering florist, to deliver any potential order, to have access a database which displays the list of delivering florist in the area of the receiver of the potential order, this database can have many attributes such as but not limited to florist satisfaction rating, percentage discount, complaints, delivery satisfaction, range of discounts etc. this database can be acceded querying a pre-populated database or by any external database. Any Originating Florist can give a score and give a review to the delivering florist the system is akin to eBay or Amazon reviews. The administrator can setup the initial language and currency for different pricing group or buyer, the buyer finally on the website chooses the language and/or currency of his predilection.

It is therefore the object of the present invention to provide a business method that allows a delivering florist to create a customized buyer experience that provides buyers specialized pricing for goods and services, buyer specific promotions, and a plurality of exclusive secondary services that distinguish the interaction the buyer has with the particular seller. The present invention accomplishes this using buyer group associations that can be linked to any originating florist or buyer as a means to offer a variable price. Furthermore, it is another object of the present invention to provide a networked social site that allows delivering florists to interact with each other through a system that records and displays purchases interactions, current buyer group discounts, and service reviews.

Other objects and advantages of the present invention will become obvious to the reader and it is intended that these objects and advantages be within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE FIGURES

FIG. 1 illustrates a system allowing sellers to provide a unique purchasing experience to buyers according an embodiment of present disclosure.

FIG. 2 is a flow diagram illustrating an exemplary method for accessing at least one web service in accordance with the present disclosure.

FIG. 3 is a flow diagram illustrating an exemplary method for accessing at least one web service in accordance with the present disclosure.

FIG. 4 illustrates an interface of the web service in accordance with an embodiment of the present disclosure.

FIG. 5 illustrates an interface of the web service in accordance with an embodiment of the present disclosure.

FIG. 6 illustrates an interface of the web service in accordance with an embodiment of the present disclosure.

FIG. 7 illustrates an interface of the web service in accordance with an embodiment of the present disclosure.

FIG. 8 illustrates an interface of the web service in accordance with an embodiment of the present disclosure.

FIG. 9 illustrates an interface of an order page of the web service in accordance with an embodiment of the present disclosure.

FIG. 10 illustrates an interface of the web service in accordance with an embodiment of the present disclosure.

While the invention is amenable to various modifications and alternative forms, specific embodiments are shown by way of example in the drawings and are described in detail. It should be understood; however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

### Overview

In the following description, numerous specific details are set forth to provide a thorough understanding of the present disclosure. However, it will be clear to one skilled in the art that the present disclosure may be practiced without some or all of these details. In other instances, well known process steps have not been described in detail in order to avoid unnecessarily obscuring the present disclosure.

A computer-implemented method for providing buyers with a unique purchasing experience based on buyer groups is disclosed. In one embodiment, a web service is provided listing a plurality of sellers. The web service displays a list of products and related information based on buyer group of a buyer. Further, the web service facilitates a sale of one or more of the products based on buyer group of the buyer. Then a seller delivers the received order and receives buyer's feedback for the sale.

### DEFINITIONS

Definitions of one or more terms that will be used in this disclosure are described below. The term, “web services” refers to web sites, mobile applications, tablet applications etc. that can be accessed via the Internet. The term, “central web service” refers to a web service that maintains a list of multiple seller web services along with related information. It also provides a central repository to maintain qualified reviews and ratings received for various individual seller web services. A third party maintains the central web service. The term, “seller web service” refers to a web service maintained by a seller. The term, “buyer” refers to a person or an organization that wishes to place an order on one of the seller web services listed on the central web service. The term, “administrator” refers to a person who has administrator rights for a web service. The administrator of the seller web service may be the seller.

### System for Facilitating Sales Based on Buyer Groups

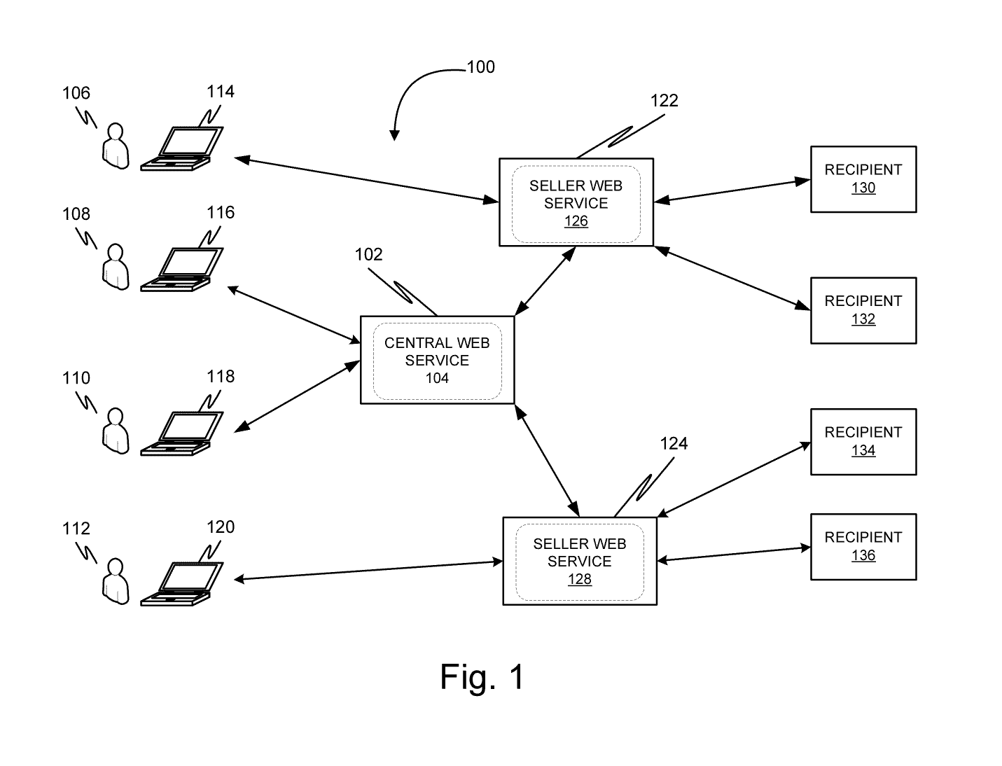

FIG. 1 illustrates a system 100 allowing sellers to provide a unique purchasing experience to buyers according an embodiment of present disclosure. The system 100 includes a central web server 102 maintaining a central web service 104. Buyers 106, 108, 110 and 112 may access the central web service 104 using their electronic communication devices 114, 116, 118 and 120 respectively. The electronic communication devices 114-120 may be smartphones, tablets, desktop computers, etc. Each electronic communication devices may include a buyer application. Further, the system 100 includes one or more seller web servers 122 and 124 maintaining one or more seller web services 126 and 128 respectively. The central web service 104 lists the one or more seller web services 126 and 128. One or more buyers 106-112 access at least one of the web services 104, 126 and 128. The web services 104, 126 and 128 provide a unique purchasing experience to the one or more buyers 106-112 based their buyer group. The unique purchasing experience includes offering specific pricing and customized secondary services. The one or more buyers 106-112 place orders for one or more products listed on the web services 104, 126 and 128 to be delivered to one or more recipients 130, 132, 134 and 136. The one or more products may be perishable products; for example, flowers, edible fruit arrangements, ice sculptures, exotic dishes and artistic arrangements. Finally, the sellers managing the seller web service 126 and 128 deliver the orders to the recipients 130-136. In an exemplary embodiment, the sellers sell flowers via the web services 104, 126 and 128. The one or more buyers 106-112 are at least one an originating florist, order gather, institutional client, regular retail buyer, branch florist and funeral home.

In another exemplary embodiment, the central web service 104 provides an order maker application, which is embedded on the seller web services 126 and 128. The order maker application may also be embedded on point of sale system of the sellers. Therefore, when a buyer lands directly on seller web service, they can avail applicable prices and purchasing process based on the buyer group. Similarly, when a buyer makes a phone order, the seller is able to use the Point of Sale to take the order and provide the correct treatment to buyer based to the buyer group.

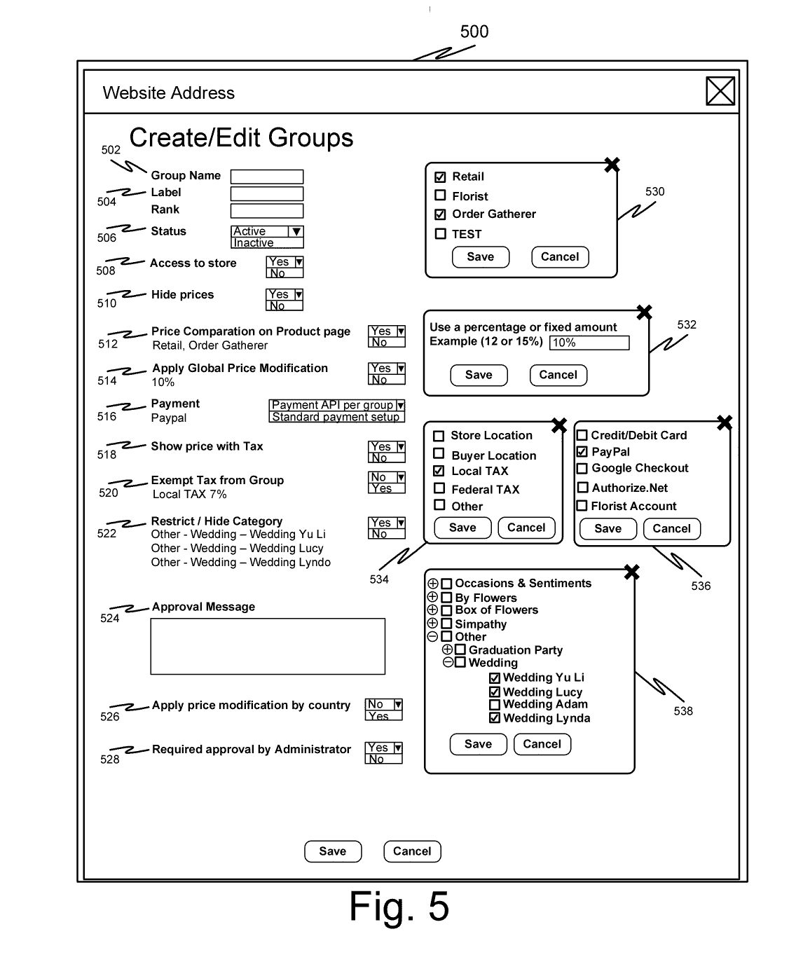

An administrator may use one or more plug-ins with the order maker application. The plug-ins that work with the order maker application may be provided or approved by administrator of the central web service 104. Administrators of the seller web services 126 and 128 may embed the plug-ins with their seller web service 126 and 128. The plug-ins allow the order maker application to include additional functionality or to seamlessly interact with three party tools. For example, an administrator may want to give price information in multiple currencies. Therefore, the administrator may use a plug-in that periodically updates the currency exchange rate received from a three party currency information system such as but not limited to FX-RATE.Net©. The plug-in may use cron Jobs to trigger a communication interaction with the third party system. Some examples of plug-ins to extend functionality include, but not limited to the, following happy hours, quick prices updates, discount coupons, gift certificates and vouchers, social buying, buyer loyal discounts, special group reports and metrics, newsletter per group, email marketing per group, recurrent order, Customer Relationship Management (CRM) etc. Some examples of plug-ins to connect with third parties include, but not limited to the following email marketing service, discount coupons, shipping services, tax information services, social networking, payment services, information services, data mining services, etc. The plug-ins are explained in further detail in conjunction with FIGS. 5, 6 and 8 below. The plug-ins allow the seller web service 126 to offer Individual buyer customized treatment on shipping systems, payment method, and tax treatment. Further, the additional features may be offered to the buyers based on their buyer group. For example, a delivering florist offers a $15 discount coupon for arrangements that has sunflowers; this coupon applies to regular retail buyers and funeral homes only, and cannot be used by order gatherers, originating Florist, institutional clients etc.

Further, the order maker application may be used to assign a specific pricing sequence per product and do not have a rigid behavior that assigns all the products to a specific pricing sequence. The user interfaces are multilingual.

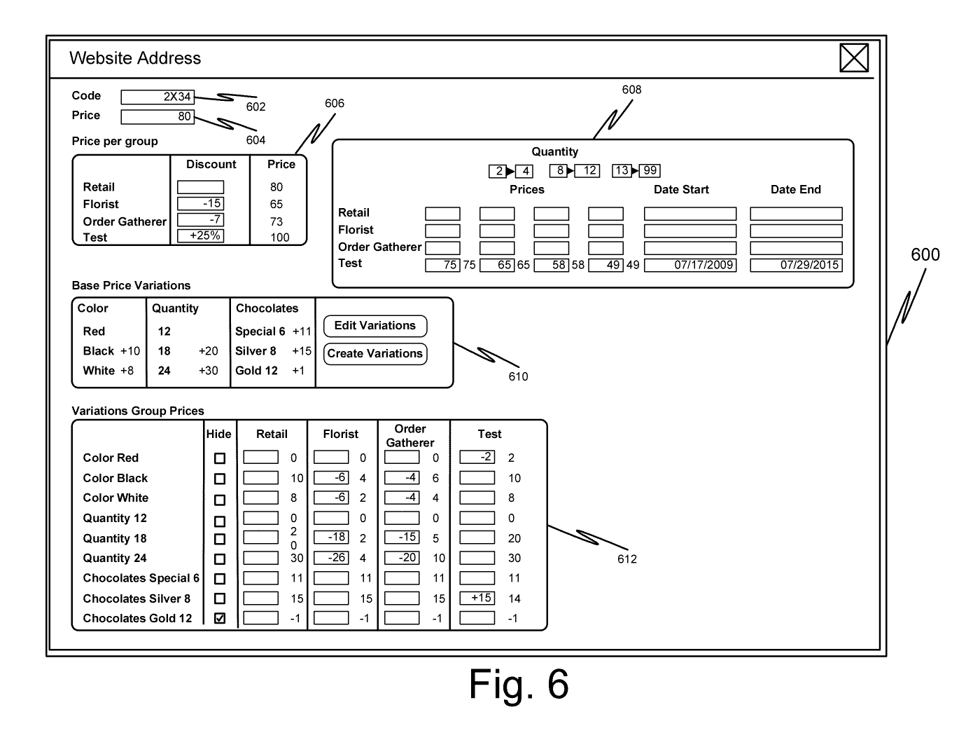

Yet further, the order maker application may be used to offer differentiated price per buyer on the product variations; for example, Primaveral Vase of Roses in variation of colors red, yellow or white. These variations add or subtract a nominal or percentage value from the base product price; and at the same time, the price of the variations could be different for each buyer group. This is explained in further detail in conjunction with FIG. 6 below.

Moreover, the order maker application may be used to hide products and prices for buyer groups on the seller web service 126, such a buyer views products and prices only according to their buyer group. This is very handy in certain situations; for example, a paid membership club may offer better discounts or better price system treatment. For example, for a dozen of roses, the price per group for institutional members is $30 and for gold club members is $22 (paid membership). Therefore, a buyer may be encouraged to join the paid membership club.

Similarly, the order maker application allows the administrator to choose whether to display the price with tax included on the public system storefront. Further, the administrator may choose to send emails and newsletters. For example, the administrator can choose to send a product notification or newsletter to one or several buyer groups only, using a third party email service.

All the information may be stored in a central database on the central web server 102. This database can be then connected to other feeding databases on the seller web servers 122 and 124. The feeding databases may be connected to the central database using an Open Database Connectivity (ODBC) open database coactivity system layer. Therefore, all the interfaces i.e. web page, point of sale, mobile application etc; are driven by the central database. This has the advantage that every modification, change or addition is applied in real time, and we avoid the need to synchronize every interface a posteriori on every transaction.

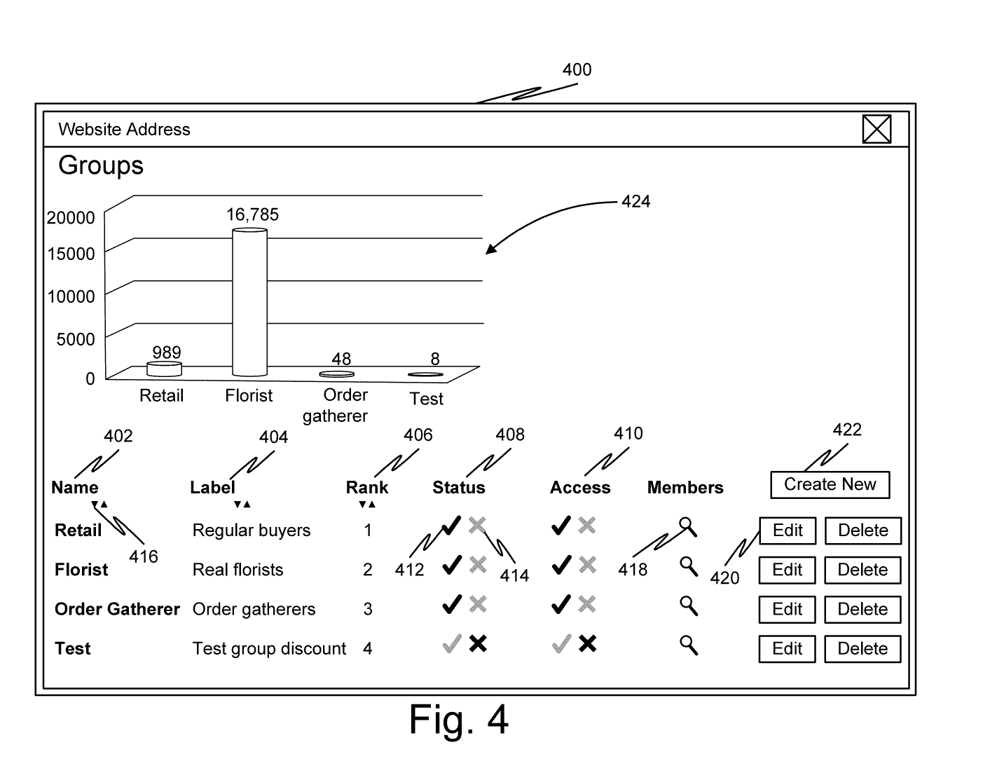

The list of buyers and all their information can be pre-populated or linked from an external database; the administrators have the ability to deactivate or activate any buyer from any group, translate buyer to another group, create another new group or simply delete any buyer. This has been explained in further detail in conjunction with FIGS. 4 and 5 below.

Further, information about a successful transaction could be sent to an external rating external system; akin to, eBay or Amazon reviews system. In this way after any transaction is completed, both the seller and the buyer can rate and review each other. This helps future buyers to pick a credible seller.

Moreover, the order maker application allows the administrator to set up a delivery schedule table in order to charge a differentiated shipping fee per buyer according to the type of delivery (hospital, funeral home, office etc), hour of delivery (9 AM, 7 PM, lunch time etc) and date (4th of July, Sunday, today, Wednesday, next week.

Yet further, the order maker application allows the administrator to update all prices in one special page, so he does not have to go product by product to update the price.

The order maker application is easily customizable and can act as a module on another integral modular system. For example, if the seller web service 126 is using WordPress™, then the administrator of the seller web service 126 may use the WordPress™ plug-in available on the central web service 104 to install the order maker application. Similarly, other WordPress™ plug-ins available on the central web service 104 to extend functionality or to seamlessly interact with three party tools may be installed on the seller web service 126.

The central web service 104 provides a social media platform that among other features includes qualified social reviews of sellers; and is connected to the seller web services 126 and 128 using constant or regular interconnection and Application Programming Interface (API) logging connection. The API connection allows any qualified member to automatically login on the seller web service from the central web service 104. In addition, all the pertinent information is pre-populated and updated in a constant stream or periodically between the central web service 104 and the seller web services 126 and 128.

### Method for Facilitating Sales Based on Buyer Groups

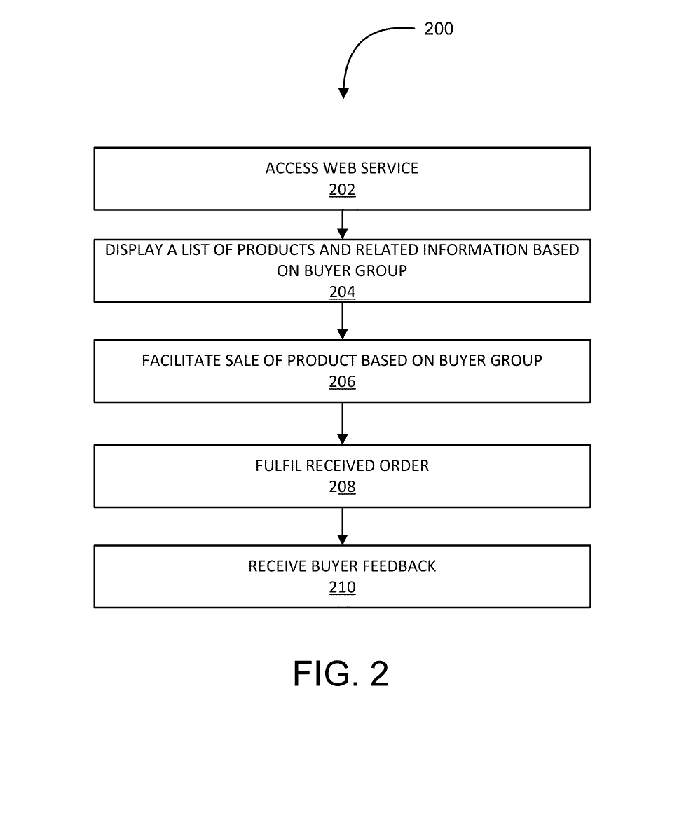

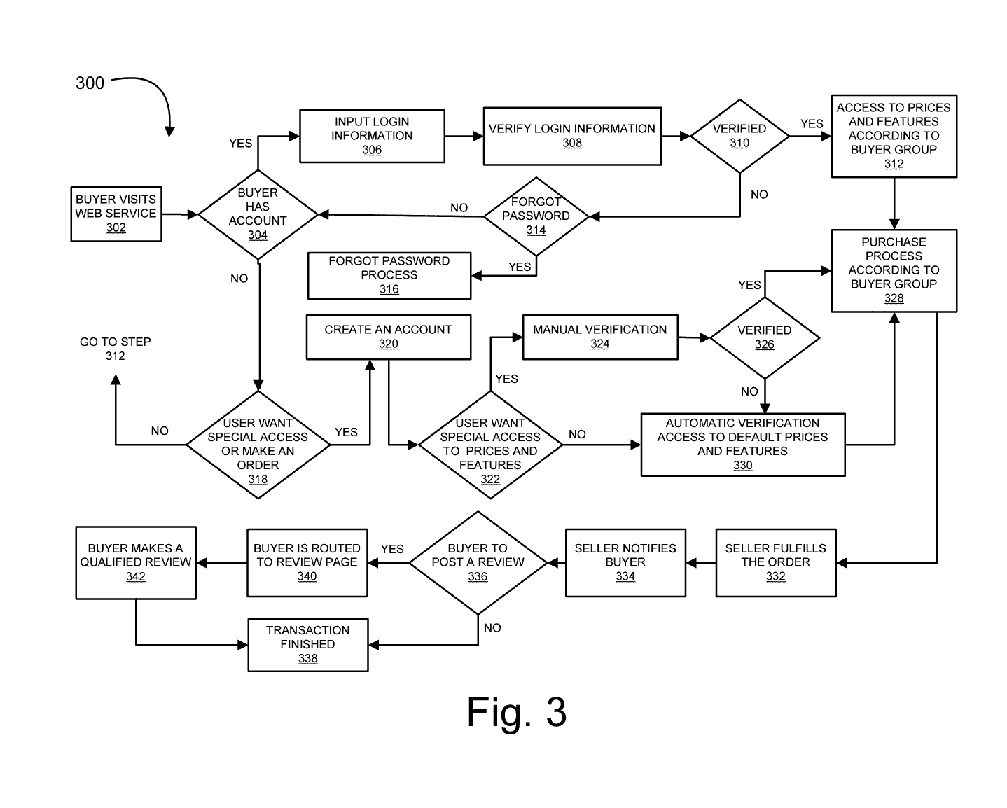

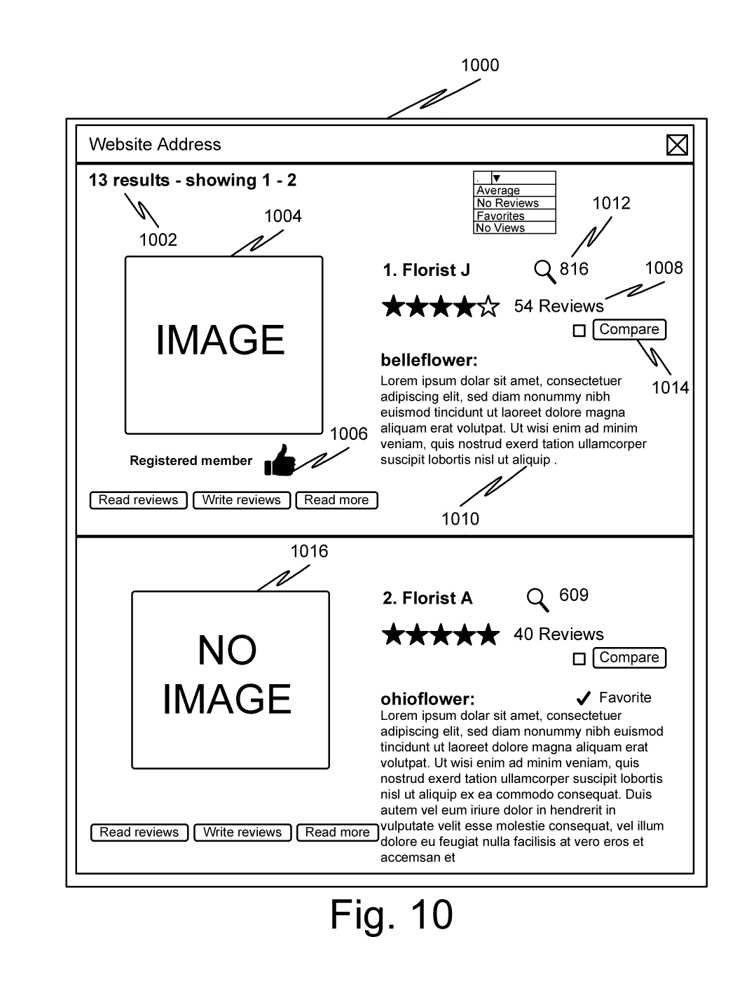

FIG. 2 is a flow diagram illustrating an exemplary method 200 for accessing at least one of the web services 104, 126 and 128 in accordance with the present disclosure. At step 202, the buyer 106 accesses one of the web services 104, 126 and 128. If the buyer 106 accesses the central web service 104, then the buyer 106 searches for an appropriate seller web service based on the requirements. For example, for perishable products the seller web service may be selected such the location of the seller is near the location of the recipient. This is explained in further conjunction with FIG. 10 below. Then the buyer 106 selects a seller web service from the seller web services listed in the search results. For example, the buyer 106 may select the seller web service 126. Thereafter, the buyer 106 is routed to the selected seller web service 126. If the buyer is logged onto the central web service 104 before selecting the seller web service 126; then the buyer 106 is automatically logged on to the selected seller web service 126. Alternatively, the buyer 106 logs onto the selected seller web service 126. However, if the buyer 106 is not registered on the web services 104 and 126, then administrator of the web services 104 and 128 may manually create an account of the buyer 106. Alternatively, the buyer 106 may create an account himself by visiting one of the web services 104 and 126, which is then validated by the administrator of the seller web service 126. Further, the administrator may place the buyer in a different buyer group after the registration process. By default, the buyer group is set to a default group. This is explained in further detail in conjunction with FIG. 3 below. Based on buyer group of the buyer 106, the seller web service 126 displays a list of products and related information at step 204. The buyer groups are explained in further detail in conjunction with FIGS. 4 and 5 below. Then at step 206, the seller web service 126 facilitates sale of product based on THE buyer group. Thereafter, at step 208 the seller of the web service 126 delivers the received order and receives feedback from the buyer 106 at step 210.

### Detailed Method for Facilitating Sales Based on Buyer Groups

FIG. 3 is a flow diagram illustrating an exemplary method 300 for accessing at least one of the web services 104, 126 and 128 from a buyer's perspective in accordance with the present disclosure. At step 302, the buyer 106 accesses the seller web service 126. Alternatively, the buyer 106 may access the central web service 104, search for the relevant sellers and select the seller web service 126. The central web service 104 redirects the buyer 106 to the seller web service 126. At step 304, it is determined if the buyer 106 has an account with the central web service 104 or the seller web service 126. If the buyer 106 has an account then at step 306, the buyer 106 inputs login information, which includes username and password. Then at step 308, the login information is verified by connecting to a user account database stored on one or both of the central web server 102 and the seller web server 122. If the user account database is stored on the central web server 102, then the login information is verified using an API connection to the central web server 102. However, if the user account database is stored on the seller web server 122 then the login information is verified using a native access store protocol that works like a social access system. Alternatively, an external system like OpenID, Facebook Connect® or any other social access system may used to verify account details. Further, all the pertinent information is pre-populated and updated in constant stream or periodically between the central web server 102 and the seller web server 122.

Next at step 310, it is determined if the login information has been verified. If the login information is verified, then the buyer 106 is provided access to prices and features according to buyer group at step 312. However, if the login information is not verified, then it is checked if the buyer 106 has forgotten password at step 314. If the buyer 106 has forgotten password, then the forget password process is initiated at step 316. However, if the buyer 106 has not forgotten password, then the method goes back to the step 304.

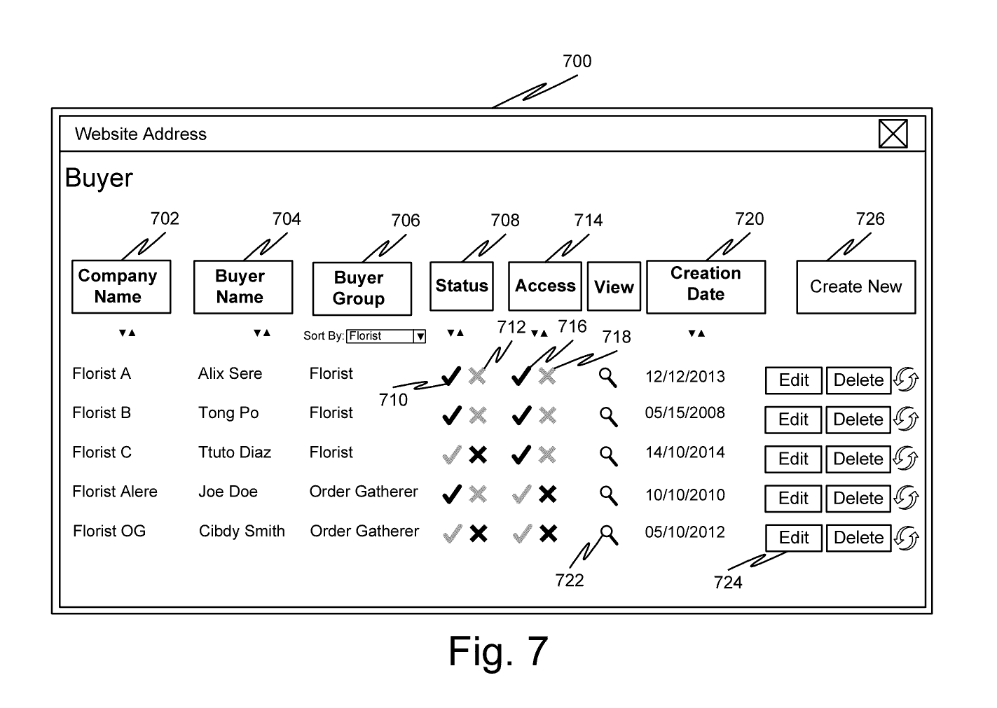

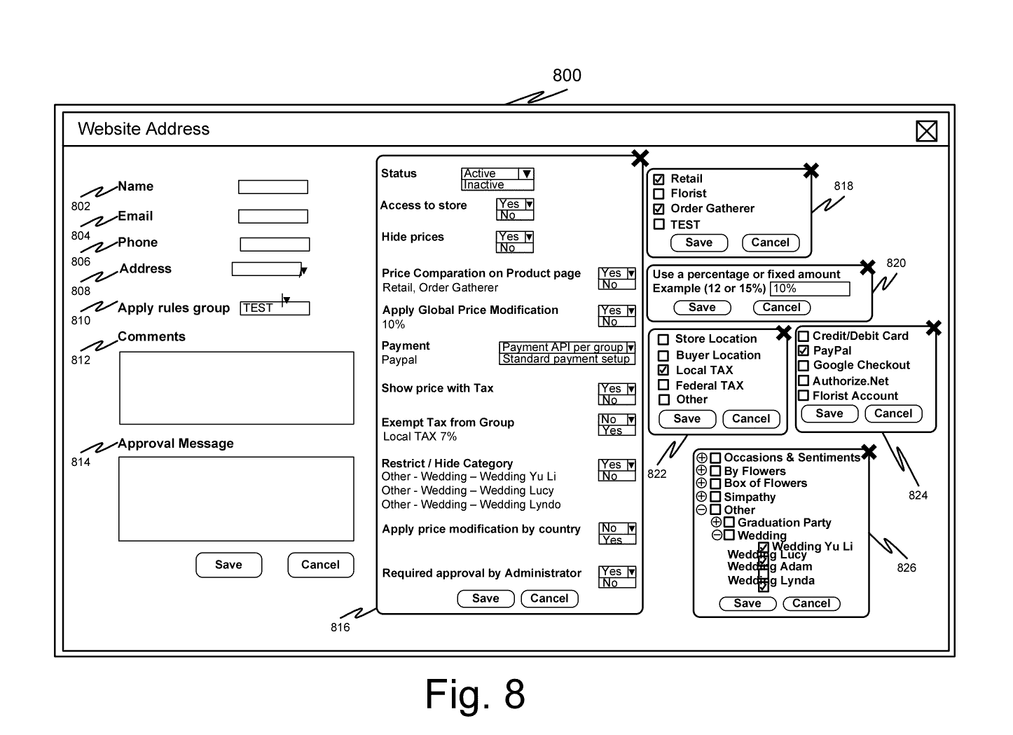

Going back to step 304, if it is determined that the buyer 106 does not have an account, then it is determined if the buyer 106 wants special access or make an order at step 318. In order to make any order the buyers need to obtain an account. If the buyer 106 does not want special access, then the method 300 goes to the step 312. However, if the buyer 106 wants special access or make an order, then the method goes to step 320, wherein the buyer 106 creates a user account. Further, the buyer 106 may apply to an appropriate buyer group. When the buyer 106 creates a user account, a create account form is presented which includes different options such as available groups with information about each group, features and advantages. Further, a buyer may create an account thorough the POS system. In this case, the seller provides the buyer with all the pertinent information of the available groups and the buyer may select an appropriate group, which is then approved by the administrator of the corresponding web service of the seller. Meanwhile the buyer has access to all features and prices according to a default group. This is explained in further detail in conjunction with FIGS. 7 and 8 below.

Next, at step 322, it is determined if the buyer 106 wants special access to prices and features. If the buyer 106 wants special access to prices and features, then manual verification is performed at step 324. If the verification is successful at step 326, then the purchase process is initiated according to buyer group at step 328. However, if the verification is not successful at step 326, then the automatic verification is performed to allow access to default prices and features at step 330. Further, if the buyer 106 does not want special access to prices and features at step 322, then the automatic verification is performed to access to default prices and features at step 330. Further, when the buyer 106 is provided access to prices and features according to buyer group at step 312, then the buyer 106 is provided access to purchase process according to buyer group at step 328.

Further, at step 328, the buyer 106 may use all the features according to the applicable buyer group to place an order. The seller delivers the order at step 332 and then notifies the buyer 106 at step 334. Thereafter, it is determined if the buyer 106 wants to place a review of the order, the process etc. If the buyer 106 does not want to place a review, then the transaction completes at step 338. The seller may encourage the buyer 106 to leave a review. The buyer 106 may be sent a reminder by email to place a review and this feature is available in the user account dashboard of the buyer 106. Therefore, if the buyer 106 wants to place a review, then the buyer 106 is routed to a review page on the central web service 104 at step 340. Then, the buyer 106 places a qualified review at step 342 and the transaction completes at step 338.

### Web Interface to Manage Buyer Groups

FIG. 4 illustrates an interface 400 of one of the central web service 104 and the seller web service 126 in accordance with an embodiment of the present disclosure. The interface 400 shows a “name” column 402 listing group names along with a “label” column 404 listing corresponding labels, a “rank” column 406, a “status” column 408 and an “access” column 410. The “name” column 402 indicates the names assigned to the individual groups. The “label” column 404 provides descriptive names of the groups. The “rank” column 406 indicates the importance of the group. The ranks are used to give priority in services, attention, etc. For example, a plug-in that manages stock will give priority to group in a rank in position 2 than a group in a rank 7, when an order is made. The “status” column 408 indicates whether the group is active or not. A status of the group “Retail” can be updated by selecting a “check” icon 412 or a “cross” icon 414. For example, a florist create a group whose members are also members of his parish. However, he wants to give discount to them only for special holydays. Otherwise, the members of this group will be treated as default group members. Therefore, the florist can activate the status of the group during special holidays.

The “access” column 410 indicates whether a group has access to the public interface or not, and can be updated by selecting the similar check or cross icons as described along with the statuses indicated in the “status” column 408. A practical example is when a group has a limited access to the public interface, but has all the privileges when makes any transaction on POS. “Arrow” icons 416 allow a user to sort the list results. A “magnifying glass” icon 418 may be used to show all the data and setup of the group. An “edit” button 420 allows a user to edit group data and setup. A “create new” button 422 allows users to create new group and provides required information. A graph 424 shows the number of members in each group. For example, the “Retail” group includes 989 members, the “Florist” group includes 16,785 members, the “Order Gatherer” group includes 48 members and the “Test” group includes eight members.

### Web Interface to Manage Buyer Groups

FIG. 5 illustrates an interface 500 of one of the central web service 104 and the seller web service 126 in accordance with an embodiment of the present disclosure. The interface 500 may be used to create and edit groups. A “group name” field 502 is used to provide name of the group. A “label” field 504 is used to provide label of the group. A “status” field 506 is used to provide status of the group. An “access to store” field 508 is used to indicate the access rights to the store. A “hide prices” field 510 is used to hide the prices on public interface, in this way the public interface acts as a catalogue. A “price comparison on product page” field 512, allows the administrator choose whether or not to show the price that belongs to the current buyer with any other group price, in order to induce the current buyer to make comparison, this is very handy if for example a paid membership club has a better discounts or better price system treatment. Further, in this way a current buyer will be encouraged to join the paid membership club. For example, for a dozen of roses, the price per group is $30 for institutional members and $22 for Gold club members (paid membership). In this case, a florist student who belongs to this member group, can observe price advantage or not of being a member of certain group.

An “apply global price modification” field 514 allows the administrator to setup a price variation on all the products. This saves time as opposed to going product by product making price variations. The variations can be nominal (amount) or percentile. A “payment” field 516 allows the administrator to setup a different payment API for the group. An “exempt tax from group” field 518 allows the administrator to setup tax status for a group.

A “restrict/hide category” field 522 allows the administrator to setup the categories which members of a group are permitted to interact with. An “approval message” field 524 allows the administrator to fill in a message that is sent to the members when the administrator approves the group and when a buyer who had applied for that group is approved.

An “apply price modification by country” field 526 allows the administrator to give special treatment to the members who belong to a group but also to members who visit the web service from a determinate zone or country. For example, a member who belongs to an order gather group, but is located in Haiti, some people there want to send flowers to a relative in USA. However, the buying power of residents of Haiti may be restricted. Therefore, the administrator may make a setup in order to give more discounts than usual to the residents of Haiti. On the other hand, an order gatherer based out of India may get orders simulating a local webpage florist in USA. For example, somebody in Miami wants to send flowers to a relative in Las Vegas, the webpage of the order gatherer based out of India can potentially obtain the order, but the final one is generated from India. In this case, the administrator makes a setup in order to charge extra. In addition, the administrator may apply a price variation to IP addresses of determined region or areas; for example, the area where the florist is located to give special discounts to all neighbors.

A “require approval by the administrator” 528 field is used to control if the group or members require approval before they use the web service or get price discounts etc

A plug-in 530 is used to assign a group type of a new group. Some properties of the selected group types may be imposed on the new group. A plug-in 532 is used to indicate the percentage or the fixed amount of applicable discount. A plug-in 534 is used to indicate the tax that needs to be applied on sales orders. A plug-in 536 is used to select the payment method. A plug-in 538 is used to select categories that need to be hidden.

### User Interface for Various Price and Product Variation

FIG. 6 illustrates an interface 600 of one of the central web service 104 and the seller web service 126 in accordance with an embodiment of the present disclosure. The interface 600 provides a price and product variation system for the use of the administrator. A “code” field 602 is used to provide a code for the particular price and product price. A “price” field 604 is used to provide a base price for the product. A “price per group” plug-in 606 allows the administrator to setup a price variation with respect to the default price. The variation can be nominal (money amount) or porcentual, positive or negative.

A “quantity” plug-in 608 allows the administrator to generate price variations according to the numbers of units demanded. It moves in ranges that the administrator can setup. It also has a date duration range. A “base price variations” plug-in 610 allows the administrator to offer different prices based on dependent product options including quantity of component parts, color, size etc. A “variation group prices” plug-in 612 allows the administrator to setup dependent product option prices according to the buyer groups.

### User Interface for Various Price and Product Variation

FIG. 7 illustrates an interface 700 of one of the central web service 104 and the seller web service 126 in accordance with an embodiment of the present disclosure. The interface 700 provides functions such as buyer creation and edition. A “company name” column 702 shows name of the company that a buyer represents. The company name is used to provide taxes exempt offers, group special treatments and discounts. A “buyer name” column 704 shows the names of the buyers. A “buyer group” column 706 shows the buyer group to which the buyer belongs. A “status” column 708 indicates whether the buyer is active or not. For example, the status of a buyer named “Alix Sere” may be updated by selecting one of a “check” icon 710 or a “cross” icon 712. For example, an originating florist requests to be included to a “florist” group, but the status is marked as cross by default until the administrator validates the information. Meanwhile the originating florist is treated as a default member or with restricted access.

An “access” column 714 indicates whether the user has access to the public interface or not. For example, the access for the buyer named “Alix Sere” may be updated by selecting a “check” icon 716 or a “cross” icon 718. A practical example is when the buyer has limited access to the public interface, but has all the privileges when he makes any transaction on the POS system. A “creation date” column 720 shows the date of creation of a buyer account.

Magnifying glass icons; for example, an icon 722, may be used to show all the data and setup of a buyer. Edit buttons; for example, an “edit” button 724, may be used to edit member data and setup. A “create new” button 726 may be used to create a new member.

### User Interface for Various Creating and Editing Buyer Profiles

FIG. 8 illustrates an interface 800 of one of the central web service 104 and the seller web service 126 in accordance with an embodiment of the present disclosure. The web interface 800 provides a form to perform functions such as buyer creation and edition; here the default setup rules apply according to the group that the member belongs to, otherwise the setup process is similar to the setup process of group creation aforementioned before, but applied to the member.

The form on the web interface 800 includes multiple fields. A “name” field 802 is used to put in name of the buyer. An “email” field 804 is used to put in email address of the buyer. A “phone” field 806 is used to put in phone number of the buyer. A “address” field 808 is used to put in address of the buyer. An “apply rules group” field 810 is used to select a group that the buyer belongs to. A “comments” field 812 is used by the administrator to fill in comments regarding the buyer. An “approval message” field 814 is used by the administrator to fill in a message that is sent to the buyer when the administrator approves the buyer or when a buyer who applies for that group is approved.

A plug-in 816 is used to provide various types of price variations. A plug-in 818 is used to provide additional group a new buyer. A plug-in 820 is used to indicate the percentage or the fixed amount of applicable discount. A plug-in 822 is used to indicate the tax, which needs to be set. A plug-in 824 is used to select the payment method that needs to be set. A plug-in 826 is used to select categories that need to be hidden.

### User Interface for an Order Page

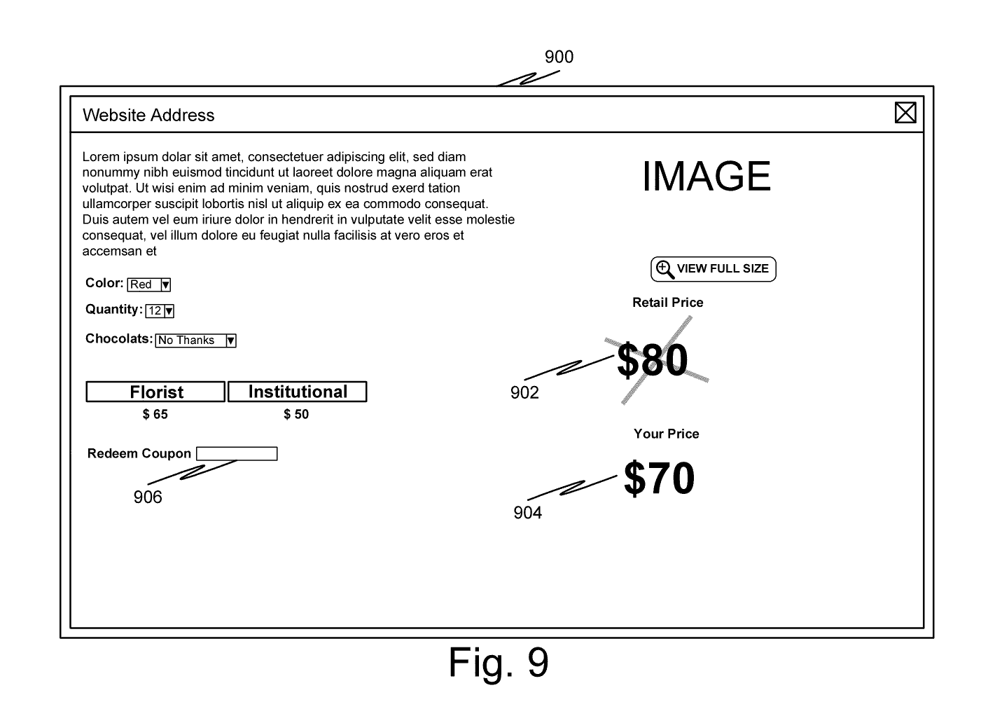

FIG. 9 illustrates an interface 900 showing an order page of the seller web service 126 in accordance with an embodiment of the present disclosure. The order page is visible to a member of specific buyer group only. Accordingly, the order pages shows the retail price 902 ($80) of the product, along with the group price 904 ($70) applicable to members of the specific buyer group.

Further, the interface 900 shows a “redeem coupon” field 906. This may be included using a plug-in. The “redeem coupon” field 906 may be setup according to buyer groups; for example, a coupon may be given to only two groups, wherein each group may have a different coupon value.

### User Interface for Search Results Page on the Central Web Service

FIG. 10 illustrates an interface 1000 of one of the central web service 104 in accordance with an exemplary embodiment of the present disclosure. The buyer 106 visits the central web service 104 to find a local delivering florist. The buyer 106 may perform a search using parameters including zip code, city and state. FIG. 10 shows the webpage that shows search results for a search query put in by the buyer 106. The webpage 1000 lists delivering florists that satisfy the search criteria. As shown in the FIG. 10, a message 1002 says “13 results—showing 1-2”, which implies that thirteen results satisfy the search query and two results are shown on the interface 1000. Delivering florists who are registered with the central web service 104 are shown above the unregistered florists. For example, a “florist J” (a registered florist) is shown above a “florist A” (an unregistered florist) in the list on the interface 1000.

For each florist listed on the webpage 1000, a set of information is provided. This includes a logo of the florists. For example, an image 1004 is the logo for the “florist J”. A message 1006 says “Registered member” which implies that the delivering florist uses API login connection to the central web service 104. Therefore, any qualified member on the central web service 104 is automatically logged onto the seller web service 126; in addition, all the pertinent information is pre-populated and updated in constant stream or periodically from the central web service 104 to the seller web service 126. The seller owning the seller web service 126 is assured that the member logged in via the central web service 104 has been verified.

The central web service 104 receives reviews for all orders placed. For example, a text 1008 says “54 reviews”, which indicates that the “florist J” received 54 reviews. A rating may be assigned to each florist in the list based on the reviews and ratings of each reviewer. Algorithms are created in a way that gives more weight to credible ratings. The algorithms to generate ratings based on reviews and ratings of the reviewers are well known to persons skilled in the art. The system review is based on credibility. The members of the web services have more credibility. Accordingly, florists, reviewers with good scores for helpful reviews, and users with accredited orders have a good credibility also; the central web service 104 recognizes reviews that come from real orders using a tracking system. For example, a user that makes an order has better credibility making a review, and if this user is a florist it better yet.

The display of the review form and its layout and process is well known to persons of ordinary skill in the art. A singular rating is generated based on different ratings provided by various buyers. Further, a Bayesian rating is used to calculate a rating of an item based on the credibility of the votes. The greater the certainty based on the number of votes, the more the Bayesian rating approximates the plain, unweighted rating. When there are very few votes, the Bayesian rating of an item will be closer to the average rating of all items.

A text 1010 shows the description about the “florist J”. A “magnifying glass” icon 1012 shows how many users have seen the description text 1010 of the “florist J” on the central web service 104. A “compare” button 1014 allows buyers to compare average rating, derivative reviews, number of reviews, members of the system network etc.

A florist profile without a logo (for example, the “florist A” has no logo 1016) belongs to a florist which has not claimed the profile on the central web service 104. Any brick and mortar florist is a potential candidate to be listed on the central web service 104. Further, the florist has not been verified at the central web service 104 yet. In this case, the “florist A” has some restrictions, because the “florist A” is not registered on the central web service 104. For the “florist A”, some information may be missing to create a full profile as the one created for the “florist J”. If a florist wants to claim a profile on the central web service 104, then he has to go through a process where the central web service 104 verifies and validates the data provided by the florist. A part of the verification process may be manual. When a florist claims its profile on the central web service 104, the florist may enhance and update the profile, place a welcome message and description, add business hours, place special coupons, receive email alerts of new reviews, reply to reviews, contest reviews, access to associated florist using API login connection from the central web service 104 and upload pictures. Any user may post a review despite the florist profile being claimed or not.

The specification has described a computer-implemented method for providing buyers with a unique purchasing experience based on buyer groups. The terms, descriptions and figures used herein are set forth by way of illustration only and are not meant as limitations. It should be anticipated that ongoing technological development would change the manner in which particular functions are performed. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the invention.

1. A computer-implemented method comprising:
accessing a web service;
displaying a list of products and related information based on a buyer group of a buyer;
facilitating a sales order of one or more of the products based on the buyer group of the buyer;
delivering the received sales order; and
receiving buyer's feedback for the sales order.

2. The computer-implemented method of claim 1, wherein the web service is a central web service accessed by the buyer, wherein the list of products and related information is displayed on a seller web service, wherein the central web service and the seller web service are connected via an Application Programming Interface (API).

3. The computer-implemented method of claim 2, wherein the central web service is a social networking platform providing profiles and qualified reviews of a plurality of seller web services.

4. The computer-implemented method of claim 1, wherein the buyer group is at least one of a retail buyer, an order gatherer, a wire service order gatherer, an originating florist, an institutional client, a funeral home and a wedding planners.

5. The computer-implemented method of claim 1, wherein the products displayed are perishable products including at least one flowers, edible fruit arrangements, ice sculptures, exotic dishes and artistic arrangements.

6. The computer-implemented method of claim 1, wherein the related information of the list of products includes at least one of price of the products, features of the products, an approach for conducting the transactions, available discounts and differentiated shipping fee per buyer group.

7. The computer-implemented method of claim 2, wherein the central web service provides an order maker application, which is embedded on the seller web service and on the point of sale system of the sellers.

8. The computer-implemented method of claim 7, wherein an administrator of a seller web service may use at least one plug-in with the order maker application, wherein the at least one plug-in allows the order maker application to include at least one of an additional functionality and interaction with three party tools.

9. The computer-implemented method of claim 8, wherein the administrator using the at least one plug-in performs at least one of assigning privileges per buyer group in order to use coupons and regular discounts, avail discounts on clearance sales, avail discounts on happy hours, special dates and holidays; creating customized products accessible to specific buyer groups with different prices per group; providing an individual buyer a customized treatment on shipping systems, payment method, and tax treatment; sending a product notification and newsletter to one or more buyer groups; obtaining currency exchange rate information periodically to update prices of the products; changing the activation status of a buyer in any buyer group, move a buyer to another group, or simply delete any buyer; creating a price per each dependent product options for each buyer group; creating a different tax system and different tax brackets for each buyer group, depending on the buyer level group tax setup; manually creating an account for a buyer and determine appropriate buyer group for the buyer; choosing to show the price that belongs to the current buyer with any other group price; creating a specific sequence in which various pricing types are applied in arriving at the final price of the product; providing multilingual user interfaces on the central web services and the seller web services; updating prices of all products from a single page; and sending information about a successful transaction to an external rating system.

10. The computer-implemented method of claim 1, wherein the buyer is an originating florist, the central web service is a social networking platform for florists, a delivering florist is an administrator of a seller web service listed on the central web service, wherein the originating florist gets automated access to special prices, products and purchase processes at the seller web service based on the buyer group, wherein the central web service and the seller web service facilitate sales order r of one or more of the products; the delivering florist delivers the received sales order; and the originating florist provides buyers feedback for the sales order at the central web service.

11. The computer-implemented method of claim 2, wherein the buyer creates an account directly on the seller web service to obtain an initial status of member of a default group and the administrator determining an appropriate buyer group of the buyer later.

12. The computer-implemented method of claim 2, wherein the central web service maintains a central database that stores all the information about the buyers, sellers, products, and purchase processes, wherein the central database is used to drive central web service and at least one seller web services, wherein the at least one seller web service maintains a feeding database, wherein the feeding database is connected to the central database via a database connection.

13. The computer-implemented method of claim 12, wherein a list of buyers and all their information is pre-populated through a link with an external database.

14. A computer readable medium encoded with a computer program comprising instructions that, when executed, operate to cause a computer to perform operations comprising:
accessing a web service;
displaying a list of products and related information based on a buyer group of a buyer;
facilitating a sales order of one or more of the products based on the buyer group of the buyer;
delivering the received sales order; and
receiving buyer's feedback for the sales order.

15. The computer readable medium of claim 14, wherein the web service is a central web service accessed by the buyer, wherein the list of products and related information is displayed on a seller web service, wherein the central web service and the seller web service are connected via an Application Programming Interface (API), wherein the central web service provides an order maker application, which is embedded on the seller web services and on point of sale of the sellers.

16. The computer readable medium of claim 15, wherein an administrator of a seller web service may use at least one plug-in with the order maker application, wherein the at least one plug-in allows the order maker application to include at least one of an additional functionality and interaction with three party tools.

17. The computer readable medium of claim 16, wherein the administrator using the at least one plug-in performs at least one of assigning privileges per buyer group in order to use coupons and regular discounts, avail discounts on clearance sales, avail discounts on happy hours, special dates and holidays; creating customized products accessible to specific buyer groups with different prices per group; providing an individual buyer a customized treatment on shipping systems, payment method, and tax treatment; sending a product notification and newsletter to one or more buyer groups; obtaining currency exchange rate information periodically to update prices of the products; changing the activation status of a buyer in any buyer group, move a buyer to another group, or simply delete any buyer; creating a price per each dependent product options for each buyer group; creating a different tax system and different tax brackets for each buyer group, depending on the buyer level group tax setup; manually creating an account for a buyer and determine appropriate buyer group for the buyer; choosing to show the price that belongs to the current buyer with any other group price; creating a specific sequence in which various pricing types are applied in arriving at the final price of the product; providing multilingual user interfaces on the central web services and the seller web services; updating prices of all products from a single page; and sending information about a successful transaction to an external rating system.

18. A system for real-time on-line sales comprising:
a central web server hosting a central web service;
at least one seller web server hosting at least one seller web service, wherein the central web service and the seller web service are connected via an Application Programming Interface (API), wherein the central web service providing an order maker application that is embedded on the seller web services, wherein the seller web service displaying a list of products and related information based on a buyer group of a buyer, facilitating a sales order of one or more of the products based on the buyer group of the buyer; and
at least one buyer communication device used by the buyer to access at least one of the central web service and the seller web service, wherein the buyer receiving the sales order and providing a feedback for the sales order.

19. The system of claim 18, wherein an administrator of a seller web service may use at least one plug-in with the order maker application; wherein the at least one plug-in allows the order maker application to include at least one of an additional functionality and interaction with three party tools.

20. The system of claim 18, wherein the administrator using the at least one plug-in performs at least one of assigning privileges per buyer group in order to use coupons and regular discounts, avail discounts on clearance sales, avail discounts on happy hours, special dates and holidays; creating customized products accessible to specific buyer groups with different prices per group; providing an individual buyer a customized treatment on shipping systems, payment method, and tax treatment; sending a product notification and newsletter to one or more buyer groups; obtaining currency exchange rate information periodically to update prices of the products; changing the activation status of a buyer in any buyer group, move a buyer to another group, or simply delete any buyer; creating a price per each dependent product options for each buyer group; creating a different tax system and different tax brackets for each buyer group, depending on the buyer level group tax setup; manually creating an account for a buyer and determine appropriate buyer group for the buyer; choosing to show the price that belongs to the current buyer with any other group price; creating a specific sequence in which various pricing types are applied in arriving at the final price of the product; providing multilingual user interfaces on the central web services and the seller web services; updating prices of all products from a single page; and sending information about a successful transaction to an external rating system.
